(19) United States
(12) Patent Application Publication
(10) Pub. No.: US 2017/0061218 A1
(43) Pub. Date: Mar. 2, 2017

(54) ROAD LIGHT MONITORING DEVICE AND MONITORING SYSTEM AND MONITORING METHOD USING SAME

(71) Applicant: HON HAI PRECISION INDUSTRY CO., LTD., New Taipei (TW)

(72) Inventor: CHIA-YEN LEE, New Taipei (TW)

(21) Appl. No.: 14/835,334

(22) Filed: Aug. 25, 2015

(51) Int. Cl. G06K 9/00; G06K 9/62; H04N 5/44; B60R 1/00; G06K 9/46

(52) U.S. Cl. CPC G06K 9/00791; B60R 1/00; G06K 9/4661; H04N 5/44; G06K 9/6201

(57) ABSTRACT

A road light monitoring device includes a light detecting unit detecting light sources and generating a voltage signal, a storage unit storing a plurality of light parameter ranges, a camera shooting unit and a processing unit. Therein, the processing unit couples with the light detecting unit, the storage unit and the camera shooting unit respectively. The processing unit obtains image data from the voltage signal obtains light parameters from the image data, compares the light parameters with the plurality of light parameter ranges, determines whether the light parameters fall into one of the plurality of light parameter ranges, controls the camera shooting unit to start to shoot images of the light sources when the light parameters do not fall into the one of plurality of light parameter ranges, and transmits the shoot images to a monitoring center via an Internet.

### FIELD

The subject matter herein generally relates to road light monitoring devices and monitoring systems and monitoring methods using same.

### BACKGROUND

There are many improper light sources endangering driving safety, such as improper light sources mounted on the vehicles, or other locations.

### BRIEF DESCRIPTION OF THE DRAWINGS

Many aspects of the present disclosure are better understood with reference o the following drawings. The components in the drawings are not necessarily drawn to scale, the emphasis instead being placed upon clearly illustrating the principles of the present disclosure. Moreover, in the drawings, like reference numerals designate corresponding pans throughout the views.

FIG. 1 is a block diagram of an embodiment of a road light monitoring device.

FIG. 2 is a block diagram of an embodiment of a road light monitoring system.

FIG. 3 is a diagrammatic view of an embodiment of an application environment of the road light monitoring system shown in FIG. 2.

FIG. 4 is a diagrammatic view of another embodiment of an application environment of the road light monitoring system shown in FIG. 2.

FIGS. 5 and 6 cooperatively constitute a flowchart of an embodiment of a road light monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “comprising,” when utilized, means “including, but not necessarily limited to”; it specifically indicates open-ended inclusion or membership in the so-described combination, group, series and the like.

The present disclosure relates to a road light monitoring system. The road light monitoring system includes at least one processing unit and a non-transitory computer readable medium coupled to the at least one processing unit and configured to store instructions for execution by the at least one processing unit. The instructions cause the at least one processing unit to obtain image data from a voltage signal generated by a light detecting unit detecting light sources. The instructions cause the at least one processing unit to obtain light parameters from the image data. The instructions cause the at least one processing unit to compare the light parameters with a plurality of light parameter ranges stored in a storage unit. The instructions cause the at least one processing unit to determine whether the light parameters fall into one of the plurality of light parameter ranges. The instructions cause the at least one processing unit to control a camera shooting unit to start to shoot images of the light sources when the light parameters do not fall into the one of plurality of light parameter ranges. The instructions cause the at least one processing unit to transmit the shoot images to a monitoring center via an Internet.

The present disclosure relates to a road light monitoring method. The road light monitoring method includes steps as follows. Generating a voltage signal in response of detecting light sources in real time. Obtaining image data from the voltage signal. Obtaining light parameters from the image data. Comparing the light parameters with a plurality of light parameter ranges stored in a storage unit. Determining whether the light parameters fall into one of the plurality of light parameter ranges. Controlling a camera shooting unit to start to shoot images of the light sources when the light parameters do not fall into the one of plurality of light parameter ranges. And transmitting the shoot images to a monitoring center via an Internet.

The present disclosure relates to a road light monitoring device. The road light monitoring device includes a light detecting unit, detecting tight sources and generating a voltage signal, a storage unit, storing a plurality of light parameter ranges, a camera shooting unit, and a processing unit. Therein the processing unit couples with the light detecting unit, the storage unit and the camera shooting unit respectively. The processing unit obtains image data from the voltage signal, obtains light parameters from the image data, compares the light parameters with the plurality of light parameter ranges, determines whether the light parameters fall into one of the plurality of light parameter ranges, controls the camera shooting unit to start to shoot images of the light sources when the light parameters do not fall into the one of plurality of light parameter ranges, and transmits the shoot images to a monitoring center via an Internet.

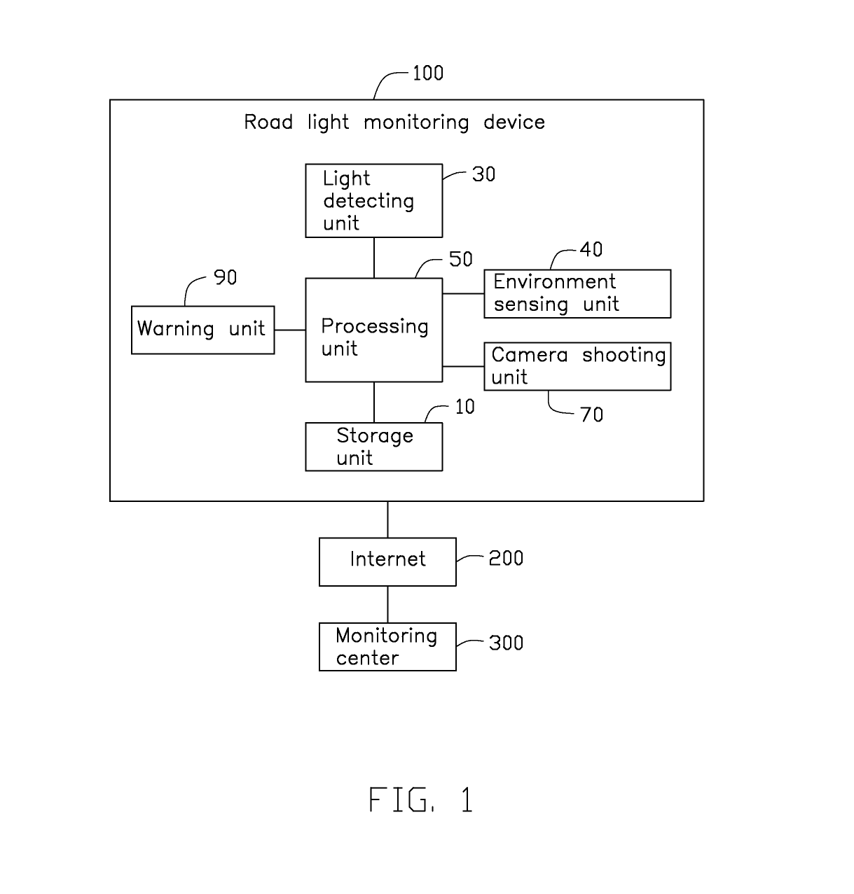

FIG. 1 shows an embodiment of a road light monitoring device 100. The road light monitoring device 100 can be mounted on a roadside, a public building located on the roadside, and/or a vehicle travelled on a road, such that an improper light source can be monitored by the road light monitoring device 100. When the road light monitoring device 100 is mounted on the roadside, and/or public building (such as a street lamp, a pole or the like) located on the roadside, the road, light monitoring device 100 can be used to monitor whether the light sources of passing vehicles meet regulations. When the road light monitoring device 100 is mounted on the roadside, the public building, and/or the vehicle travelled on the road, the road light monitoring device 100 can be used to monitor whether the light sources except the light sources of the passing vehicles, such as light sources of an advertising board, meet regulations.

The road tight monitoring device 100 can communicate with a monitoring center 300 via an Internet 200, such that the improper light sources can be reported, and an accident triggered by the improper light sources can be avoided. The Internet 200 can be but not limited to Internet, On-Demand Virtual Leased Line, wireless network including WIFI. Bluetooth or the like, Telephone network including GPRS, CDMA or the like, Broadcast networks, or the like.

The road light monitoring; device 100 can include a storage unit 10, a light detecting unit 30, an environment sensing unit 40, a processing unit 50, a camera shooting unit 70 and a warning unit 90. The storage unit 10, the light detecting unit 30, the environment sensing unit 40, the camera shooting unit 70 and the warning unit 90 can be electrically coupled to the processing unit 50. In at least one embodiment, the road light monitoring device 100 can further include a power unit (not shown). The power unit can be used for powering the road light monitoring device 100. The power unit can be an alternating current supplied by a municipal power supply or a battery.

The storage unit 10 can be used to store a plurality of light parameter ranges. The plurality of light parameter ranges can include but not limited to illuminance range, color temperature range, lighting direction range, lighting position range, or the like. In at least one embodiment, the light parameter ranges can be defined according to need. For example, when the road light monitoring device 100 is used to monitor front lights of the passing vehicles, the light parameter ranges can be corresponding to the front lights, including but not limited to head lights, fog lights, turn lights, and emergency lights. Another example, when the road light monitoring device 100 is used to monitor side lights of the passing vehicles, the light parameter ranges can be corresponding but not limited to width lamps. Another example, when the road light monitoring device 100 is used to monitor back lights of the passing vehicles, the light parameter ranges can be corresponding but not limited to fog lights. turn lights, stop lights, emergency lights, and backup lights. Another example, when the road light monitoring device 100 is used to monitor the light sources except the light sources of the passing vehicles, the light parameter ranges can be a light parameter range meeting regulations.

The storage unit 10 can be used to store a plurality of environment parameter ranges for all kinds of environment conditions, including but not limited to illuminance range of daytime, illuminance range of night, illuminance range of foggy day, and air humidity range.

The storage unit 10 can be further used to store a relationship recording relationships between the plurality of light parameter ranges and the plurality of environment conditions. When the environment condition is foggy day, the light parameter range corresponding to the environment condition can include but not limited to a set of light parameters of foggy day such that the fog lights of the passing vehicles can be detected and monitored. When the environment condition is night, the light parameter range corresponding to the environment condition can include but not limited to a set of light parameters of headlights and a set of light parameters of width lights, such that the head lights and the width lamps of the vehicles can be detected and monitored.

In at least one embodiment, the storage unit 10 can be an internal storage system, such as a flash memory, a random access memory (RAM) for temporary storage of information, and/or a read-memory (ROM) for permanent storage of information.

In at least one embodiment, the storage unit 10 can also be a storage system, such as a hard disk, a storage card, or a data storage medium. The storage unit 10 can include volatile and/or non-volatile storage devices.

In at least one embodiment, the storage unit 10 can include two or more storage devices such that one storage device is a memory and the other storage device is a hard drive. Additionally, the storage unit 10 can be respectively located either entirely or partially external relative to the road light monitoring device 100.

The light detecting unit 30 can be mounted on an outside of the road light monitoring device 100. The light detecting unit 30 can be used to detect the light sources around the light detecting unit 30 by a way of image detecting and further, convert detected data into voltage signal. In at least one embodiment, the light detecting unit 30 can be but not limited to image detector.

The environment sensing unit 40 can be mounted on the outside of the road light monitoring device 100. The environment sensing unit 40 can be used to sense environment around the environment sensing unit 40 and further, convert sensed data into voltage signal. In at least one embodiment, the environment sensing unit 40 can be used to sense the environment parameters including but not limited to illuminance, and air humidity.

The processing unit 50 can be used to obtain image data from the voltage signal generated by the light detecting unit 30, and further obtain the light parameters from the image data, including but not limited to illuminance, color temperature, lighting direction, and lighting position.

The processing unit 50 can be used to obtain the sensed data from the voltage signal generated by the environment sensing unit 40 and further, obtain environment parameters from the sensed data, including but not limited to illuminance and air humidity.

The processing unit 50 can be used to determine the environment condition according to the environment parameters.

The processing unit 50 can be further used to compare the light parameters with the plurality of light parameter ranges corresponding to the environment condition, and determine whether the light parameters fall into one of the plurality of light parameter ranges corresponding to the environment condition.

In at least one embodiment, the processing unit 50 can be a central processing unit, a digital signal processor, or a single chip, for example.

The camera shooting unit 70 can be started to shoot images of the improper light sources when the processing unit 50 determines that the light parameters do not fall into the one of the plurality of light parameter ranges corresponding to the environment condition. in at least one embodiment, the shoot images can be transmitted to the monitoring center 300. The camera shooting unit 70 can be but not limited to camera.

The warning unit 90 can be started to warn the improper light sources when the processing unit 50 determines that the light parameters do not fall into the one of the plurality of light parameter ranges corresponding to the environment condition. In at least one embodiment, the warning unit 90 can be but not limited to light Warning device, voice warning device or the like.

In at least one embodiment, the environment sensing unit 40 can be omitted. The processing unit 50 can be used to determine whether the light parameters fall into the one of the plurality of light parameter ranges just according to the light parameters and the light parameter ranges.

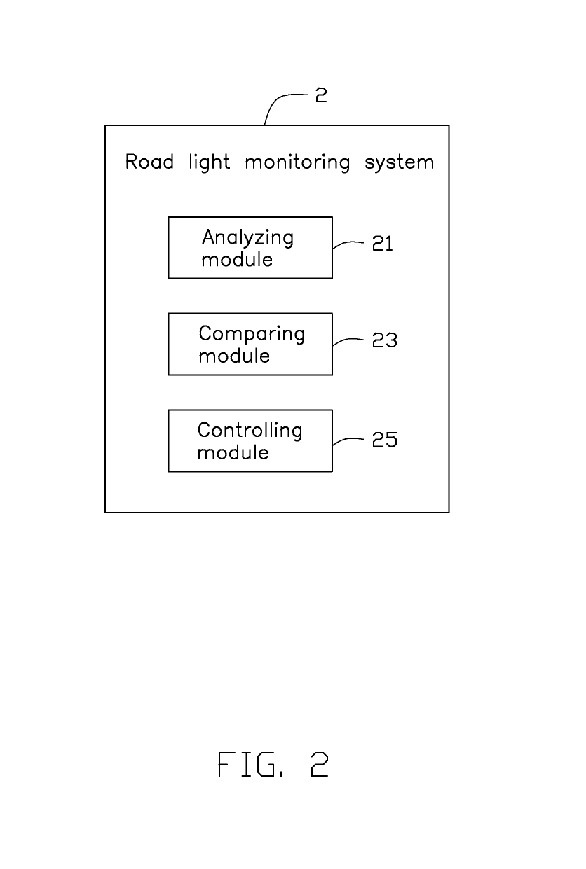

FIG. 2 shows a road light monitoring system 2. The road light monitoring system 2 can include a plurality of modules. The plurality of modules can include an analyzing module 21, a comparing module 23 and a controlling module 25. The analyzing module 21, the comparing module 23 and the controlling module 25 can be stored in the storage unit 10 of the road light monitoring device 100, and further applied on the processing unit 50 of the road light monitoring device 100. The modules of the road light monitoring system 2 can include separated functionalities represented by hardware or integrated circuits, or as software and hardware combinations, such as a special-purpose processor or a general-purpose processor with special-purpose firmware.

The analyzing module 21 can be used to obtain image data from the voltage signal generated by the light detecting unit 30, and further obtain the light parameters from the image data, including but not limited to the illuminance, the color temperature, the lighting direction, and the lighting position.

The analyzing module 21 can be further used to obtain the sensed data from the voltage signal generated by the environment sensing unit 40, and further obtain the environment parameters from the sensed data, including but not limited to the illuminance and the air humidity.

The comparing module 23 can be used to determine the environment condition according to the environment parameters.

The comparing module 23 can be further used to compare the light parameters with the plurality of light parameter ranges corresponding to the environment condition, and determine whether the light parameters fall into one of the plurality of light parameter ranges corresponding to the environment condition.

The controlling module 25 can be used to control the camera shooting unit to start to shoot images of the improper light sources when the comparing module 23 determines that the light parameters do not fall into the one of plurality of light parameter ranges corresponding to the environment condition. The controlling module 25 can be further used to transmit the shoot images to the monitoring center 300 via the Internet 200.

The controlling module 25 can be further used to control the warning unit 90 to start to warn the improper light source when the comparing module 23 determines that the light parameters do not fall into the one of plurality of light parameter ranges corresponding to the environment condition.

In at least one embodiment, the comparing module 23 can be used to determine whether the light parameters fall into the one of the plurality of light parameter ranges just according to the light parameters and the light parameter ranges.

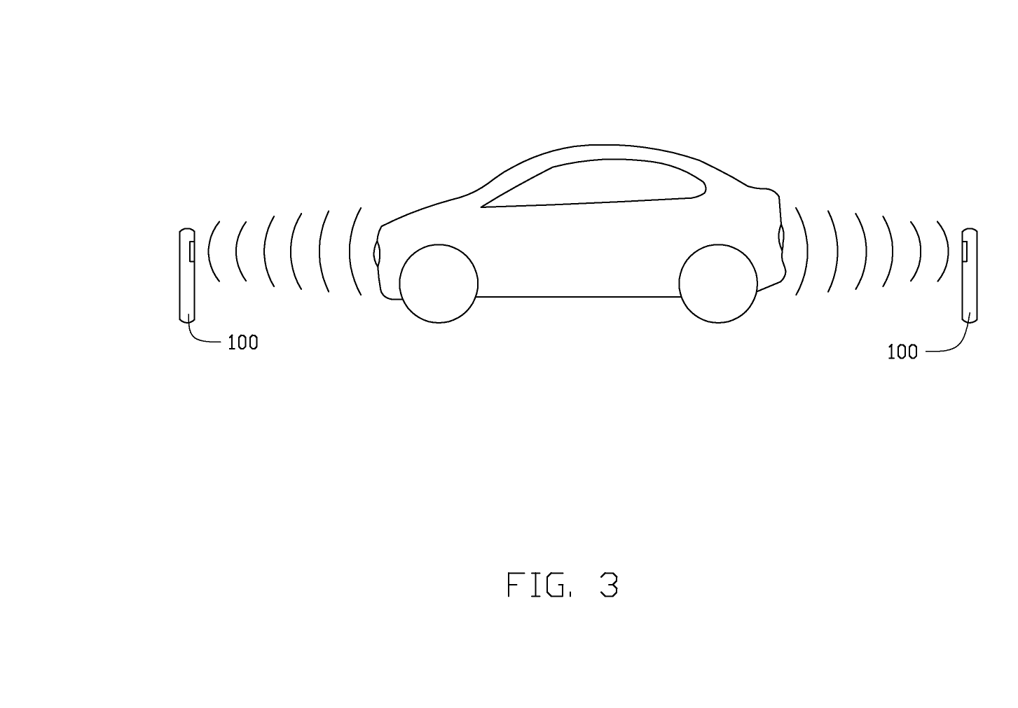

FIG. 3 shows an embodiment of a diagram of an application environment of the road light monitoring system 2. In at least one embodiment, the road light monitoring system 2 can include at least one road light monitoring device 100, and the at least one road light monitoring device 100 can be mounted on the roadside. One of the at least one road light monitoring device 100 can be used to monitor the front lights of the passing, vehicles, and another of the at least one road light monitoring device 100 can be used to monitor the back lights of the passing vehicles.

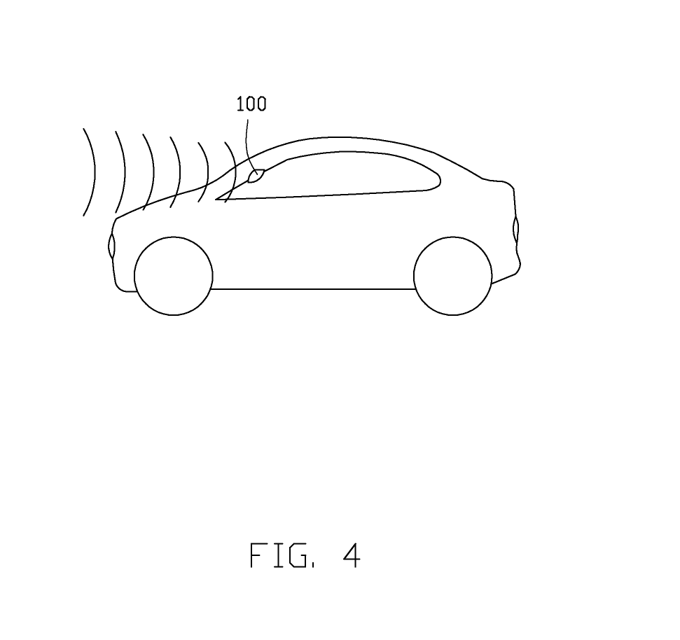

FIG. 4 shows another embodiment of a diagram of an application environment of the road light monitoring system 2. In at least one embodiment, the road light monitoring system 2 can include at least one road light monitoring device 100, and the at least one road light monitoring device 100 can be mounted on the vehicles, and used to monitor the light sources except the vehicle's light source.

In at least one embodiment, when the road light monitoring device 100 is used to monitor the light sources of passing vehicles, the road light monitoring device 100 can be mounted to a lower position on the roadside or the public building of the roadside. When the road light monitoring device 100 is used to monitor the light sources except the passing vehicles' light sources, the road light monitoring device 100 can be mounted to a higher position on the roadside or the public building of the roadside.

In at least one embodiment, as the light sources of the vehicles on the road is moving, but other light sources are not moving, so the road light monitoring device 100 can distinguish the light sources of the vehicles from the light sources of the others' light sources according to the changing frequency of the light sources when the road light monitoring device 100 is mounted on the roadside or the public building of the roadside.

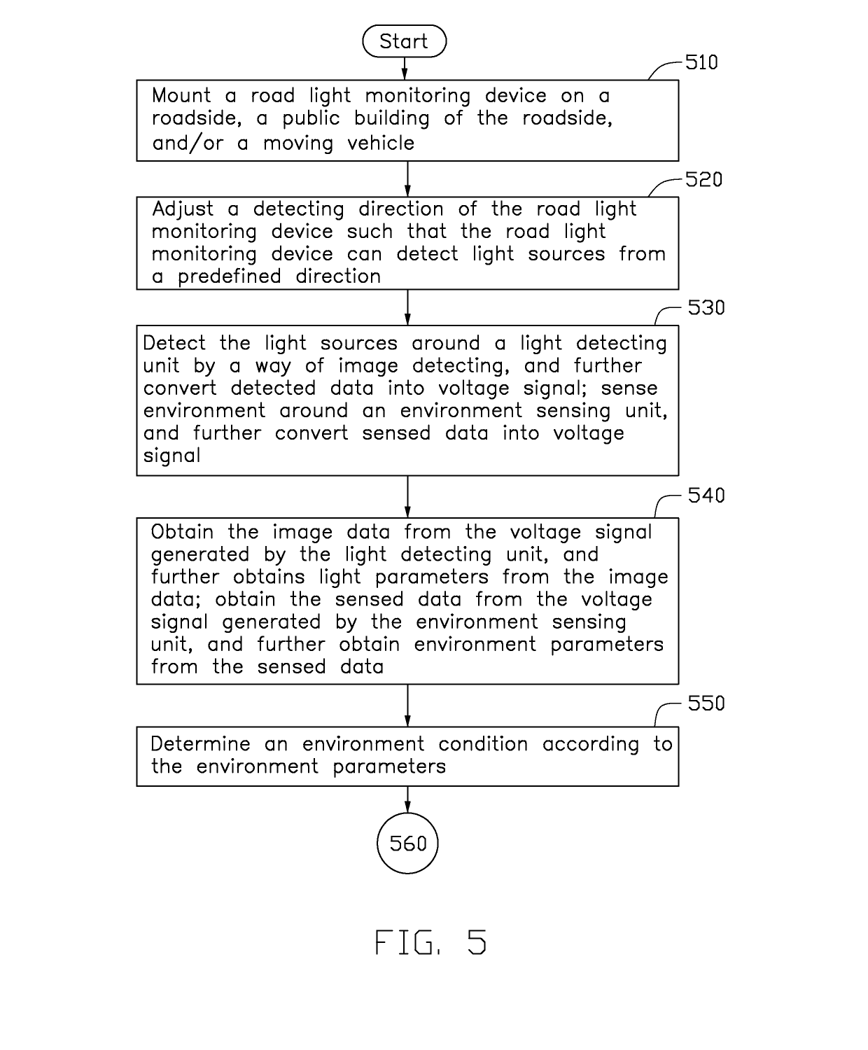

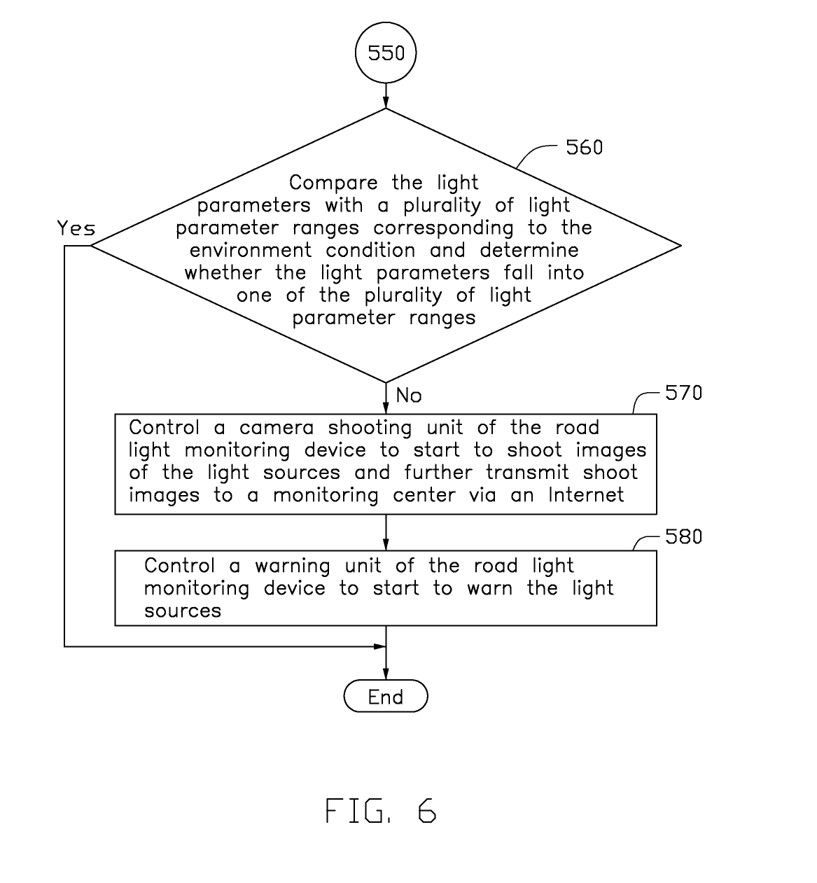

FIGS. 5 and 6 cooperatively constitute a single flowchart of a road light monitoring method. The road light monitoring method is provided by way of example, as there are a variety of ways to carry out the method. The road light monitoring method described below can be carried out using the configurations illustrated in FIG. 2, for example, and various elements of these figures are referenced M explaining the example method. Each block shown in FIGS. 5 and 6 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 510.

At block 510, a road light monitoring device is mounted on a roadside, a public building of the roadside, and/or a moving vehicle.

At block 510, a detecting direction of the road lit monitoring device can be adjusted such that the road light monitoring device can detect the light source from a predefined direction.

At block 530. a light detecting unit of the road light monitoring device detects light sources around the light detecting unit by a way of image detecting, and further, convert detected data into voltage signal, an environment sensing unit of the road light monitoring device senses environment around the environment sensing unit, and further, convert sensed data into voltage signal.

At block 540, an analyzing module obtains the image data from the voltage signal generated by the light detecting unit, and further obtains light parameters from the image data, including but not limited to illuminance, color temperature, lighting direction, and lighting position: the analyzing module further obtains the sensed data from the voltage signal generated by the environment sensing unit, and further obtain environment parameters from the sensed data, including but not limited to illuminance and air humidity.

At block 550, a comparing module determines an environment condition according to the environment parameters.

At block 560, the comparing module compares the light parameters with the plurality of light parameter ranges corresponding to the environment condition and determines whether the light parameters fall into one of the plurality of light parameter ranges corresponding to the environment condition, if yes, the process goes to end, otherwise, the process goes to block 570.

At block 570, a controlling module controls a camera shooting unit of the road light monitoring device to start to shoot images of the improper light sources and further transmit shoot images to a monitoring center via an Internet.

At block 580, the controlling module controls a warning unit of the road light monitoring device to start to warn the improper light sources.

The embodiments shown and described above are only examples. Many details are often found in the art such as the features of road light monitoring device and monitoring system and monitoring method using same. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A road light monitoring system comprising:
at least one processing unit; and
a non-transitory computer readable medium coupled to the at least one processing unit and configured to store instructions for execution by the at least one processing unit, the instructions causing the at least one processing unit to:
obtain image data from a voltage signal generated by a light detecting unit detecting light sources;
obtain light parameters from the image data;
compare the light parameters with a plurality of light parameter ranges stored in a storage unit,
determine whether the light parameters fall into one of the plurality of light parameter ranges;
control a camera shooting unit to start to shoot images of the light sources when the light parameters do not fall into the one of plurality of light parameter ranges; and
transmit the shoot images to a monitoring center via an Internet.

2. The road light monitoring system of claim 1, wherein the instructions cause the at least one processing unit to:
obtain sensed data from a voltage signal generated by an environment sensing unit by sensing environment;
obtain environment parameters from the sensed data;
determine a environment condition according to the environment parameters;
determine whether the light parameters fall into the one of the plurality of light parameter ranges corresponding to the environment condition;
control the camera shooting unit to start to shoot images of the improper light sources when the light parameters do not fall into the one of plurality of light parameter ranges corresponding to the environment condition; and
transmit the shoot images to a monitoring center via an Internet.

3. The road light monitoring system of claim 1, wherein the instructions cause the at least on processing unit to:
control a wanting unit to start to warn the light sources when the light parameters do not fall into the one of plurality of light parameter ranges.

4. The road light monitoring system of claim 3, wherein the instructions cause the at least one processing unit to:
obtain sensed data from a voltage signal generated by an environment sensing unit by sensing environment;
obtain environment parameters from the sensed data;
determine a environment condition according to the environment parameters;
determine whether the light parameters fall into the one of the plurality of light parameter ranges corresponding to the environment condition;
control the camera shooting unit to start to shoot images of the improper light sources when the light parameters do not fall into the one of plurality of light parameter ranges corresponding to the environment condition;
transmit the shoot images to a monitoring center via an Internet; and
control the waning unit to start to warn the light source when the light parameters do not fall into the one plurality of light parameter ranges corresponding to the environment condition.

5. The road light monitoring system of claim 4, wherein the light parameters comprise illuminance, color temperature, lighting direction, and lighting position, and the environment parameters comprise illuminance and air humidity.

6. A road light monitoring method comprising:
generating a voltage signal in response of detecting light sources in real time;
obtaining image data from the voltage signal;
obtaining light parameters from the image data;
comparing the light parameters with a plurality of light parameter ranges stored in a storage unit;
determining whether the light parameters fall into one of the plurality of light parameter ranges;
controlling a camera shooting unit to start to shoot images of the light sources when the light parameters do not fall into the one of plurality of light parameter ranges; and
transmitting the shoot images to a monitoring center via an Internet.

7. The road light monitoring method of claim 6, wherein the road light monitoring method further comprises:
generating a voltage signal in response of sensing environment;
obtaining sensed data from the voltage signal;
obtaining environment parameters from the sensed data;
determining a environment condition according to the environment parameters;
determining whether the light parameters fall into the one of the plurality of light parameter ranges corresponding to the environment condition;
controlling the camera shooting unit to start to shoot images of the improper light sources when the light parameters do not fall into the one of plurality of light parameter ranges corresponding to the environment condition; and
transmitting the shoot images to a monitoring center via an Internet.

8. The road light monitoring method of claim 6, wherein the road light monitoring method further comprises:
controlling a warning unit to start to warn the light sources when the light parameters do not fall into the one of plurality of light parameter ranges.

9. The road light monitoring method of claim 8, wherein the road light monitoring method further comprises;
generating a voltage signal in response of sensing environment;
obtaining sensed data from the voltage signal;
obtaining environment parameters from the sensed data;
determining a environment condition according to the environment parameters;
determining whether the light parameters fall into the one of the plurality of light parameter ranges corresponding to the environment condition;
controlling the camera shooting unit to start to shoot images of the improper light sources when the light parameters do not fall into the one of plurality of light parameter ranges corresponding to the environment condition;
transmitting the shoot images to a monitoring center via an Internet; and
controlling the warning unit to start to warn the light source when the light parameters do not fall into the one of plurality of light parameter ranges corresponding to the environment condition.

10. The road light monitoring method of claim 9, wherein the light parameters comprise illuminance, color temperature, lighting direction, and lighting position, and the environment parameters comprise illuminance and air humidity.

11. A road light monitoring device comprising:
a light detecting unit, detecting light sources and generating a voltage signal;
a storage unit, storing a plurality of light parameter ranges;
a camera shooting unit: and
a processing unit;
wherein the processing unit couples with the light detecting unit, the storage unit and the camera shooting unit respectively, the processing unit obtains image data from the voltage signal, obtains light parameters from the image data, compares the light parameters with the plurality of light parameter ranges, determines whether the light parameters fall into one of the plurality of light parameter ranges, controls the camera shooting unit to start to shoot images of the light sources when the light parameters do not fall into the one of plurality of light parameter ranges, and transmits the shoot images to a monitoring center via an Internet.

12. The road light monitoring device of claim 11, wherein the road light monitoring device further comprises:
an environment sensing unit sensing environment in real time and generating a voltage signal;
wherein the processing unit obtains sensed data from the voltage signal, obtains environment parameters from the sensed data, determines a environment condition according to the environment parameters, determines whether the light parameters fall into the one of the plurality of light parameter ranges corresponding to the environment condition, controls the camera shooting unit to start to shoot images of the light sources when the light parameters an not fall into the one of plurality of light parameter ranges corresponding to the environment condition, and transmits the shoot images to a monitoring center an Internet.

13. The road light monitoring device of claim 11, wherein the road light monitoring device further comprises
a warning unit coupled to the processing unit, wherein the processing unit controls the warning unit to start to warn the light sources when the light parameters do not fall into the one of plurality of light parameter ranges.

14. The road light monitoring device of claim 13, wherein the road light monitoring device further comprises:
an environment sensing unit sensing environment in real time and generating a voltage signal;
wherein the processing unit obtains sensed data from the voltage signal, obtains environment parameters from the sensed data, determines a environment condition according to the environment parameters, determines whether the light parameters fall into the one of the plurality of light parameter ranges corresponding to the environment condition, controls the camera shooting unit to start to shoot images of the light sources when the light parameters do not fall into the one of plurality of light parameter ranges corresponding to the environment condition, transmits the shoot images to a monitoring center via an Internet, and control the warning unit to start to warn the light source when the light parameters do not fall into the one of plurality of light parameter ranges corresponding to the environment condition.

15. The road light monitoring device of claim 14, wherein the light parameters comprise illuminance, color temperature, lighting direction, and lighting position, and the environment parameters comprise illuminance and air humidity.

16. The road light monitoring device of claim 14, the road light monitoring device is mounted on a roadside, a public building mounted on the roadside, or a vehicle.
